(19) United States
(12) Patent Application Publication
(10) Pub. No.: US 2016/0371630 A1
(43) Pub. Date: Dec. 22, 2016

(54) PERSONAL INVENTORY MANAGEMENT FOR A QUANTIFIED HOME

(71) Applicant: FUJITSU LIMITED, Kawasaki-shi (JP)

(72) Inventors: Jorjeta G. JETCHEVA, San Jose, CA (US); Daisuke MASHIMA, Sunnyvale, CA (US)

(21) Appl. No.: 14/742,603

(22) Filed: Jun. 17, 2015

(51) Int. Cl. G06Q 10/08; G06Q 50/00; G06Q 30/06

(52) U.S. Cl. CPC G06Q 10/087; G06Q 30/0625; G06Q 50/01

(57) ABSTRACT

A system includes a quantified home, a mobile client device and an inventory analytics server. The quantified home includes an item set and one or more reader devices. The item set includes an item and a tag that is affixed to the item. The tag is configured to be monitored by the one or more reader devices. The mobile client device is configured to register the item with a personal inventory and receive description data describing a set of conditions associated with the item. The one or more reader devices are configured to monitor movement of the tag within the quantified home and generate history data describing the movement. The inventory analytics server is configured to receive the description data and history data. The inventory analytics server is configured to determine that a condition included in the set of conditions has been met and initiate a user specified action.

### FIELD

The embodiments discussed herein are related to personal inventory management for a quantified home.

### BACKGROUND

Inventory management systems have traditionally focused on the commercial and industrial applications. Commercial and industrial applications of inventory management systems may include manual entry of information describing items to be included in the inventory management system. The process of manually entering this information may be tedious and require a large amount of time. Commercial and industrial applications of inventory management systems also do not include many of the features that personal users would find helpful and interesting. As a result, existing commercial and industrial applications of inventory management systems would not work well if applied to personal users.

### SUMMARY

According to an aspect of an embodiment, a personal inventory management system includes a quantified home, a mobile client device and an inventory analytics server. The quantified home includes an item set and one or more reader devices. The item set includes an item and a tag that is affixed to the item. The tag is configured to be monitored by the one or more reader devices. The tag may be monitored proactively by the one or more reader devices without user intervention. Movement of the tag indicates movement of the item. The mobile client device is configured to register the item with a personal inventory. The mobile client device receives description data describing a set of conditions associated with the item. The set of conditions are specified by a user. The one or more reader devices are configured to monitor movement of the tag within the quantified home and generate history data describing movement of the item within the quantified home. The inventory analytics server is configured to receive the description data and history data. The inventory analytics server is configured to determine that a condition included in the set of conditions has been met. The inventory analytics server may proactively initiate a user specified action responsive to the condition being met. For example, if the item moves to a garbage area or a vehicle area of the home, the inventory analytics server may update the personal inventory to indicate that the item is not available or will not be available in the future. Other actions are possible. For example, a new item may arrive at the quantified home. The new item may be tagged. The presence of the new item may be detected. For example, a reader device may be affixed to an appliance such as a refrigerator. The reader device may detect the presence of the new item.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment for personal inventory management for a quantified home;

FIG. 2 is a block diagram illustrating an example mobile client device;

FIG. 3 shows an example flow diagram of a method to register an item with the personal inventory management system;

FIG. 4 shows an example flow diagram of a method to track an item in the quantified home; and

FIG. 5 shows an example flow diagram of a method to update the status of an item with the personal inventory management system.

### DESCRIPTION OF EMBODIMENTS

The embodiments discussed herein are related to personal inventory management for a quantified home. The personal inventory management may be provided by a personal inventory management system. The personal inventory management system may include a quantified home, a mobile client device including a mobile application and an inventory analytics server. These elements of the personal inventory management system will be described below.

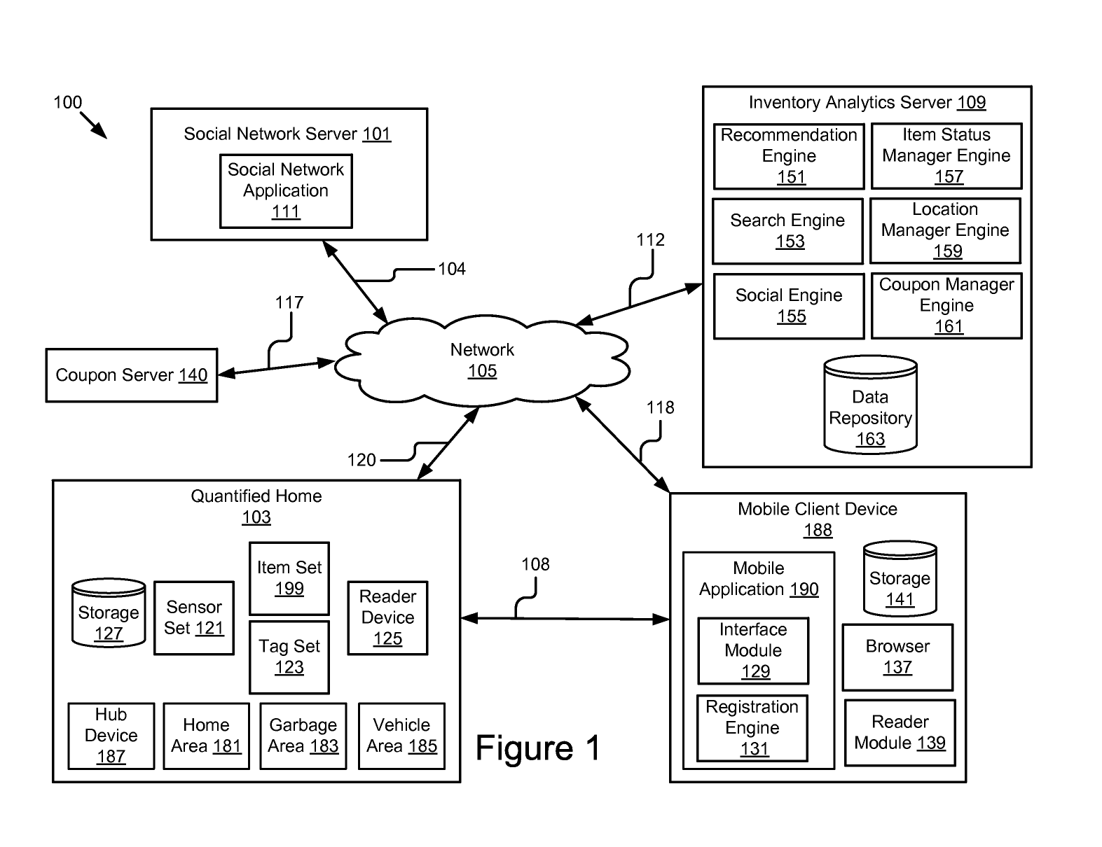

The quantified home may include a residence of the user. The quantified home may include one or more items that are monitored by the personal inventory management system. The quantified home will be described in more detail below with reference to FIGS. 1-5.

The mobile client device may include any processor-based computing device. For example, the mobile client device may include one or more of a wearable computer (e.g., a smartwatch, smart glasses, fitness tracker, etc.), a set top box, a tablet computing device, a laptop and a personal computer. The mobile client device may be a special-purpose computing device such as a smartphone executing the mobile application. The mobile client device may store the mobile application on a tangible computer-readable storage medium. The mobile client device may include a processor for executing the mobile application. The mobile application may provide a user interface for the personal inventory management system. The mobile application may receive data describing one or more items included in the quantified home. The mobile application may include code and routines configured to provide some or all of the following functionality to the user: enable the user to register one or more items with the personal inventory management system; enable the user to provide queries to the personal inventory management system and receive responses to the queries; enable the user to receive recommendations, coupons and product expiration notices from the personal inventory management system; enable the user to connect one or more social networks to the personal inventory management system; enable the user to borrow, buy or sell items or services among their social network connections. The mobile client device and the mobile application will be described in more detail below with reference to FIGS. 1-5.

The inventory analytics server may include a server including a processor, a memory and one or more software engines for storing data received from the mobile client device and providing one or more services to the mobile client device. The inventory analytics server will be described in more detail below with reference to FIGS. 1-5.

The quantified home, the mobile client device and the inventory analytics server may be communicatively coupled to one another via a network. Communications among these entities may be secured to protect the privacy and integrity of user data. For example, the communications may be encrypted or routed through a virtual private network or some other technology configured to maintain privacy of the user data. Other methods for protecting the privacy of the user data is described below with reference to FIG. 1, including, for example, one or more of the following security features: cryptography; hashing; partial encryption; end-to-end encryption; digital signature or message authentication code (MAC), communication via a virtual private network (VPN) and/or Transport Layer Security (TLS) included in the network 105; and any technology that is a derivative or a fork of the previously described security features.

The personal inventory management system may monitor one or more items included in the quantified home. The one or more items may include any tangible object associated with the quantified home which is affixed with an identification tag (herein “a tag” or “the tag”) and registered with the personal inventory management system. For example, the user may manually affix or couple a tag to an item. The tag may include a radio-frequency identification tag (an “RFID” tag) or a near field communication tag (an “NFC” tag). For the purpose of clarity, both the RFID tag and the NFC tag will be referred to herein as “a tag” or “the tag.” The item may have a bar code or a quick response code (herein “QR code”). The mobile client device may include a camera and software for reading bar codes or QR codes.

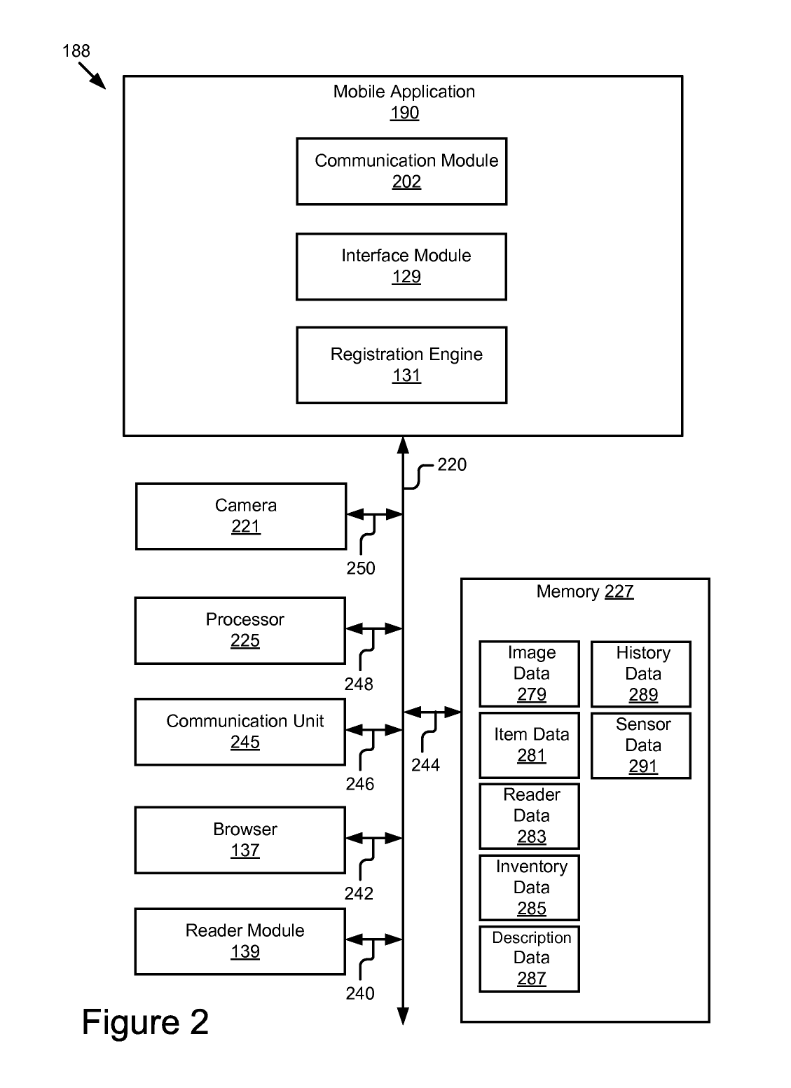

The user may register one or more items with the personal inventory management system. For example, the user may affix a tag to an item. The user may then register the tagged item with the personal inventory management system. The mobile client device may determine the identity of the tagged item and other descriptive information for the tagged item based on the bar code or the QR code. For example, the mobile client device may perform one or more of the following steps: take a picture of the tagged item; determine the presence of a bar code or QR code in the picture; read the bar code or QR code included in the picture; and determine the identity of the tagged item and information describing the tagged item based on data included in the bar code or the QR code. For example, the mobile client device may determine that the tagged item is an eight ounce can of tomato soup. The mobile application included the mobile client device may generate inventory data describing the tagged item. For example, the inventory data may describe the item as one eight ounce can of tomato soup based on information included in the bar code or the QR code. The inventory data may include other information about the item such as the date when the item was purchased, an expiration date for the item, etc. Such information may be entered either manually or automatically by using an OCR technology. The network may transmit the data to the inventory analytics server. In this way, the user may register items with the personal inventory management system. Optionally, one or more items may be registered at the point of sale. For example, a point of sale device may include functionality to scan the bar code of the item and register the item with the personal inventory management system. The inventory data will be described in more detail below with reference to FIGS. 1 and 2.

The quantified home may include one or more areas. The one or more areas may include rooms in the residence or portions of the residence that serve one or more purposes. For example, the quantified home may include one or more of the following: a garbage area; a vehicle area; and a home area. The garbage area may include portion of the quantified home where garbage is aggregated for disposal, recycling or composting. The vehicle area may include portion of the quantified home where the user stores their vehicle. For example, the vehicle area may include a garage, drive way, parking strip or other parking area for a vehicle. The home area may include any portion of the quantified home that is not the garbage area or the vehicle area. The quantified home may include one or more different home areas. For example, a bedroom may include one home area, a bathroom may include a different home area and a television room may include yet another home area. In one embodiment, an area may be a closet, drawer or cabinet. The different areas of the quantified home may be referred to individually or collectively as “an area” or “the areas.”

The one or more areas included in the quantified home may include one or more reader devices. For example, the quantified home may include one or more areas and individual areas may include different reader devices. The reader device may include a device configured to detect and monitor the presence of tags. The reader device may include hardware to wirelessly communicate with the mobile client device. For example, the reader device may include a wireless antenna for wirelessly transmitting data to the mobile client device. The reader device may provide information to the mobile client device describing the presence of a tag in an area of the quantified home.

In some embodiments, a reader device may be affixed or coupled to a surface of the different areas. For example, a reader device is affixed to an entrance of a room in the quantified home (e.g., any ingress or egress point of an area such as a wall, floor, ceiling, light switch, etc.) so that the reader device may detect and monitor tags that enter or exit the room. In this way, individual reader devices may be stationary. In some embodiments, the reader device may be included in a dynamic object that moves about the quantified home. For example, a user's mobile client device (e.g., smartphone) may be configured to function as a reader device. In another example, the quantified home may include a robotic device such as a robotic vacuum cleaner or sweeper. The robotic device may include a reader device. For example, the robotic device may be a robotic vacuum that travels to different areas of the quantified home to clean the areas and detect tags present in the areas. The robotic device may determine its own location using an onboard global positioning system, wireless signal triangulation or any other methodology configured to determine the location of the robotic device.

In one embodiment, the reader device may be configured so that the user touches the tag of an item to the reader device so that the reader device may store data indicating that the item has entered or exited the area. For example, the tag may be an NFC tag and the reader device may include an NFC reader.

The one or more areas of the quantified home may include one or more sensors. The one or more sensors may include devices configured to determine one or more physical attributes of the area where they are located. For example, an area may include a sensor to measure the temperature, humidity, luminance, presence of smoke or carbon monoxide or any other physical attribute of the area. The one or more sensors may also include a motion detector sensor or some other sensor configured to detect and track motion in the area where the sensor is located. Individual areas of the quantified home may include different sensors. The sensor may include hardware to wirelessly communicate with the mobile client device. For example, the sensor may include a wireless antenna for wirelessly transmitting data to the mobile client device. The sensor may wireless transmit sensor data describing the one or more physical attributes of the area where the sensor is located.

The personal inventory management system may track one or more tagged items as they move within the different areas of the quantified home. For example, a tagged item may enter a bathroom. The bathroom may include a reader device that detects the presence of the tagged item. The reader device included in the bathroom may monitor the presence of the tagged item in the bathroom. The reader device included in the bathroom may transmit history data to the mobile client device indicating that the tagged item has entered the bathroom. The history data for a tagged item may describe the location history for the tagged item within the quantified home. The tagged item may leave the bathroom and enter the bedroom. The reader device included in the bathroom may detect that tagged item has left the bathroom. The bedroom may include a different reader device. The reader device included in the bedroom may transmit history data to the mobile client device indicating that the tagged item has entered the bedroom. In this way, the personal inventory management system may store history data describing the movement of the one or more items within the quantified home. If a user wants to locate a tagged item, they may query the mobile application and the mobile application may provide them with information describing the location of the tagged item.

The physical attributes of the different areas of the quantified home may be described by sensor data which is recorded by the one or more sensors included in the different areas. A sensor may transmit sensor data to the mobile client device describing the physical attributes of the area where the sensor is located. For example, a tagged item being moved from a bathroom to a bedroom. A sensor included in the bathroom may transmit sensor data to the mobile client device describing a physical attribute of the bathroom while the tagged item was located in the bathroom. A different sensor included in the bedroom may transmit sensor data to the mobile client device describing a physical attribute of the bedroom while the tagged item is located in the bedroom. Some items may be affected by the physical attributes of the environments where they are located. For example, assume that the tagged item is a medicine that is affected if it is exposed to temperatures exceeding a certain threshold. The user may determine what temperatures the medicine was exposed to by querying the mobile application and the mobile application may provide them with information describing the temperatures which of the medicine was exposed to while in the quantified home. The information may be displayed by a GUI which the mobile application causes to be displayed by the mobile client device.

As described above, the personal inventory management system may include inventory data describing the items included in the quantified home. The inventory data may include a count for one or more categories of items. For example, assume that the category is “eight ounce can of tomato soup.” The inventory data may describe how many eight ounce cans of tomato soup are included in the quantified home. When an item enters the garbage area or the vehicle area, the personal inventory management system may update the inventory for the item to indicate that the item has left the quantified home or is expected leave the future. For example, assume that the inventory data indicates that the quantified home includes three eight ounce cans of tomato soup. The user may eat one of the eight ounce cans of tomato soup and then place the empty can in the garbage area of the quantified home. The personal inventory management system may detect the presence of the empty can in the garbage area and update the inventory data to indicate that the quantified home now includes two eight ounce cans of tomato soup. The user may provide an input specifying that the quantified home maintain an inventory of at least three eight ounce cans of tomato soup. The personal inventory management system may provide a notification to the user that they need to buy an eight ounce can of tomato soup when they visit the grocery store. The personal inventory management system may identify a coupon for purchasing the eight ounce can of tomato soup at the grocery store. The notification may include the coupon for purchasing the eight ounce can of tomato soup.

The personal inventory management system may provide one or more recommendations to the user. For example, the personal inventory management system may: identify that an item is missing from the quantified home and notify the user about the status of the item; identify that an item is close to an expiration date and notify the user about the status of the item; suggest that an item be purchased at a retail store or an online store; enable automatic or manual online purchases of one or more items; identify one or more coupons for items that the user may purchase; identify alternative items which the user may purchase and notify the user about the alternative item (the alternative item may include cheaper or have less environmental impact versus the item which the user has purchased in the past); identify if an item has been exposed to physical attributes that affect the item and notify the user about the status of the item (and, if needed, update the inventory to indicate a new expiration date for the item); identify if an item is leaving an area where it is supposed to be constrained and notify the user about the status of the item (or trigger a security system included in the quantified home about a possible burglary); and identify if an item is entering an area where it is not supposed to be located (e.g., the item is a gun that enters a child's bedroom) and notify the user about the status of the item.

The personal inventory management system may include social network functionality. For example, one or more users of the personal inventory management system may live within a predefined area of one another. The users may modify the privacy settings of the personal inventory management system so that other users with whom they share a connection on a social network may view the items in their quantified home. Users may use this functionality to borrow items from one another. Users may also use this functional to sell items to one another either in person or online. Users may also advertise their availability to assist other users. For example, a user may advertise that they are available to assist other users in moving furniture. Users may contact one another via an interface of the mobile application so that they may borrow items, sell items or provide services to one another. If a user cannot borrow or buy an item from other users, the personal inventory management system may identify a coupon for purchasing the item from a vendor and provide the coupon to the user.

FIG. 1 illustrates a block diagram of an example operating environment 100 for personal inventory management for a quantified home. The operating environment 100 includes a social network server 101, an inventory analytics server 109, a mobile client device 188, a quantified home 103 and a coupon server 140.

In one embodiment, these entities of the operating environment 100 may be communicatively coupled via a network 105. For example, the social network server 101 may be communicatively coupled to the network 105 via a signal line 104. The inventory analytics server 109 may be communicatively coupled to the network 105 via a signal line 112. The mobile client device 188 may be communicatively coupled to the network 105 via a signal line 118. The quantified home 103 may be communicatively coupled to the network 105 via a signal line 120. The coupon server 140 may be communicatively coupled to the network 105 via a signal line 117. Some elements of the operating environment 100 may be coupled to one another without use of the network 105. For example, the quantified home 103 may be communicatively coupled to the mobile client device 188 via a signal line 108.

In one embodiment, one or more communications among the entities of the operating environment 100 may be configured to ensure the confidentiality and integrity of the information and data included in these communications. For example, communications via signal lines 104, 112, 118, 108, 120, 117, 104 and 108 may include one or more of the following security features: cryptography; hashing; partial encryption; end-to-end encryption; digital signature or MAC, communication via a VPN and/or TLS included in the network 105; and any technology that is a derivative or a fork of the previously described security features.

While FIG. 1 illustrates one social network server 101, one inventory analytics server 109, one mobile client device 188, one quantified home 103 and one coupon server 140, the disclosure applies to a system architecture including one or more social network servers 101, one or more update servers 109, one or more mobile client devices 188, one or more quantified homes 103 and one or more coupon servers 140. Furthermore, although FIG. 1 illustrates one network 105 coupled to the entities of the operating environment 100, in practice one or more networks 105 of various types may include connected to these entities.

The network 105 may include a conventional type, wired or wireless, and may have numerous different configurations including a star configuration, a token ring configuration, or other configurations. Furthermore, the network 105 may include a local area network (LAN), a wide area network (WAN) (e.g., the Internet), or other interconnected data paths across which multiple devices may communicate. In one embodiment, the network 105 may include a peer-to-peer network. The network 105 may also be coupled to or include portions of a telecommunications network for sending data in a variety of different communication protocols. In one embodiment, the network 105 includes Bluetooth® communication networks or a cellular communications networks for sending and receiving data including via short messaging service (SMS), multimedia messaging service (MMS), hypertext transfer protocol (HTTP), HTTPS, direct data connection, WAP, e-mail, etc. In one embodiment, the network 105 may include a GPS satellite for providing GPS coordinates to the mobile client device 188 or the mobile client device 188. The network 105 may include a mobile data network such as 3G, 4G, long term evolution (LTE), Voice-over-LTE (“VoLTE”), or any other mobile data network or combination of mobile data networks. In one embodiment, the network 105 may include a combination of different networks.

The mobile client device 188 may include a mobile computing device that includes a memory and a processor. For example, the mobile client device 188 may include a laptop computer, a desktop computer, a tablet computer, a mobile telephone, a personal digital assistant (“PDA”), a mobile e-mail device, a portable game player, a portable music player, a set top box, a connected device or wearable computer (e.g., a smartwatch, smart glasses, fitness tracker, etc.), a television with one or more processors embedded therein or coupled thereto, or other electronic device capable of accessing the network 105. A user may interact with the mobile client device 188. The mobile client device 188 may send and receive data to and from other entities of the operating environment 100 via the network 105. The mobile client device 188 may be communicatively coupled to the quantified home 103 via a signal line 108. The signal line 108 may include a hard wired or wireless communicative coupling between the mobile client device 188 and the quantified home 103 or an element of the quantified home 103. In one embodiment, the quantified home 103 or elements of the quantified home 103 may access the network 105 at least in part via the mobile client device 188. In one embodiment, the mobile client device 188 may include an element of the quantified home 103.

The mobile client device 188 may include a mobile application 190, a browser 137, a reader module 139 and a storage 141. The mobile client device 188 may include one or more other elements described below with reference to FIG. 2. For example, the mobile client device 188 may include a processor, a memory, a camera and a communication unit.

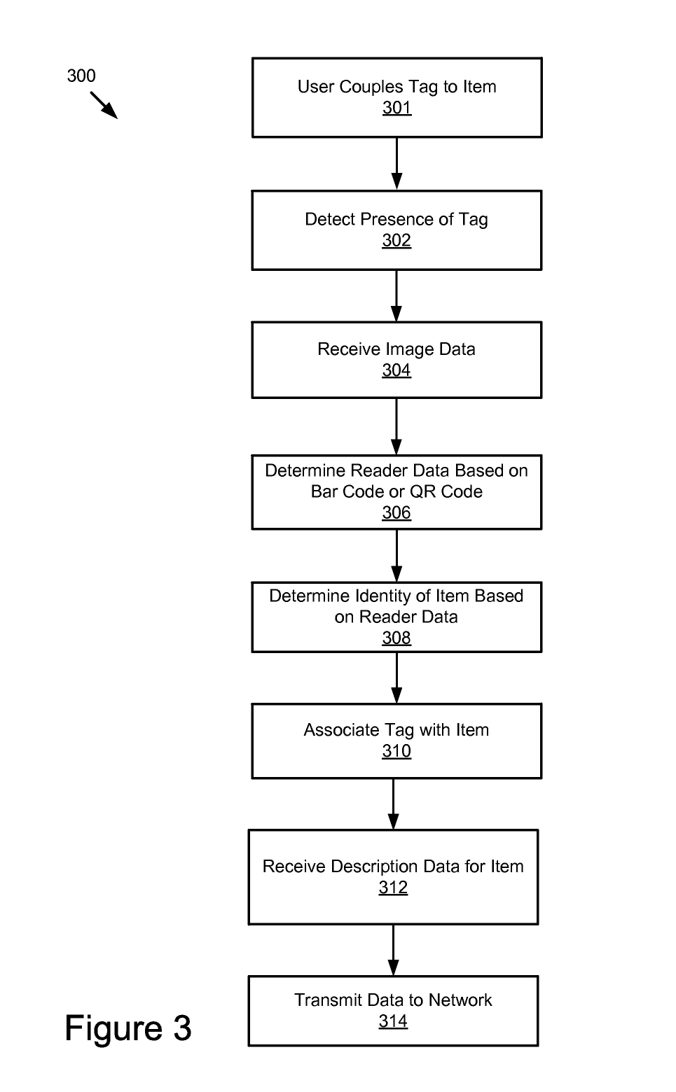

The mobile application 190 may include code and routines configured to perform or control performance of one or more steps of the methods 300, 400, 500 described below with reference to FIGS. 3, 4 and 5 when executed by the processor of the mobile client device 188.

In one embodiment, the mobile application 190 may cause a display of the mobile client device 188 to display a graphical user interface (“GUI”) including functionality to enable the user to register one or more items with the personal inventory management system. The GUI may include one or more graphical display elements, user-selectable graphical elements or user input fields. The GUI may be configured to provide the user with one or more of the following services: enable the user to provide queries to the personal inventory management system; enable the user to receive responses to the queries provided to the personal inventory management system; enable the user to receive recommendations, coupons and product expiration notices from the inventory analytics server 109; enable the user to connect one or more social networks to the inventory analytics server 109; enable the user to borrow or sell items to social network connections; enable the user to share services with one or more of their social network connections; and enable the user to receive services or offers from one or more of their social network connections. In one embodiment, the inventory analytics server 109 may be an element of the mobile application 190.

The mobile application 190 may include one or more of an interface module 129 and a registration engine 131. The interface module 129 may include code or routines configured to cause the processor of the mobile client device 188 to generate and display the GUI of the mobile application 190 when executed by the processor. The registration engine 131 may include code and routines configured to cause the processor of the mobile client device 188 to perform one or more steps of method 300 described below with reference to FIG. 3. For example, the registration engine 131 may include functionality to enable the user to register one or more items with the personal inventory management system via the mobile application 190. In one embodiment, one or more aspects of the registration engine 131 may be an element of a point of sale device. In this way, the one or more items may include registered with the personal inventory management system at the point of sale.

In one embodiment, one or more of the interface module 129 and the registration engine 131 may include elements that are independent of the mobile application 190. For example, one or more of the interface module 129 and the registration engine 131 may be stored on the storage 141 and executed by a processor of the mobile client device 188. In another example, one or more of the interface module 129 and the registration engine 131 may be stored on a server such as the inventory analytics server 109 and executed by a processor of the inventory analytics server 109.

In one embodiment, one or more elements of the inventory analytics server 109 may be stored and executed by the mobile client device 188. For example, one or more of the recommendation engine 151, the search engine 153, the social engine 155, the expiration manger engine 157, the location manager engine 159, the coupon manager engine 161 and the data repository 159 may be elements of the mobile application 190 or the storage 141. These elements of the inventory analytics server 109 will be described in more detail below.

In one embodiment, one or more of the mobile application 190, the interface module 129 and the registration engine 131 may be implemented using hardware including a field-programmable gate array (“FPGA”) or an application-specific integrated circuit (“ASIC”). In some other embodiments, the mobile application 190, the interface module 129 and the registration engine 131 may be implemented using a combination of hardware and software. The mobile application 190, interface module 129 and registration engine 131 may be stored in a combination of the devices and servers, or in one of the devices or servers of the operating environment 100. The mobile application 190, interface module 129 and registration engine 131 are described in more detail below with reference to FIGS. 2-5.

The storage 141 may include a non-transitory storage medium that stores data for providing the functionality described herein. The storage 141 may include a dynamic random access memory (DRAM) device, a static random access memory (SRAM) device, flash memory, or some other memory devices. In one embodiment, the storage 141 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The browser 137 may include code and routines for enabling the mobile client device 188 to access webpages and other content via the network 105 when executed by the processor of the mobile client device 188. For example, the browser 137 may include a web browser.

The reader module 139 may include code and routines for enabling the mobile client device 188 to detect and read or more of the following: an RFID tag; an NFC tag; a QR code; and a bar code. The reader module 139 may work in combination with a camera of the mobile client device 188 when detecting and reading QR codes and bar codes. The mobile client device 188 and the camera are described in more detail below with reference to FIG. 2. The functionality of the reader module 139 is described in more detail below with reference to method 300 of FIG. 3.

In one embodiment, the mobile client device 188 may include a smartphone accessing the network 105. The network 105 may be a mobile data network as described above. The mobile client device 188 may be accessing the network 105 to enable the user to register one or more items with the personal inventory management system.

In one embodiment, the mobile client device 188 may be accessing the network 105 to enable the user to access one or more of the services provided by the inventory analytics server 109. For example, the mobile client device 188 may be accessing the network 105 to enable the user to access a service provided by one or more of the recommendation engine 151, the search engine 153, the social engine 155, the expiration manger engine 157, the location manager engine 159, and the coupon manager engine 161. In one embodiment, the user may access one or more of these services via a GUI of the mobile application 190 which is displayed by the mobile client device 188. In another embodiment, the user may access one or more of these services via a web interface of the browser 137 which is displayed by the mobile client device 188. For example, the mobile client device 188 may be a personal computer including the browser 137 and the user may access one or more of these services via the browser 137. In this way, the user may access the personal inventory management system via the mobile application 190 or the browser 137. Accordingly, it is to be understood that any GUI described herein with reference to the mobile application 190 may also be displayed and accessible by the user via the browser 137.

The quantified home 103 may include a residence or some other personal abode of the user. For example, the quantified home 103 may include a house, an apartment, a condo, an apartment or any other personal residence of the user. The quantified home 103 may send and receive data to and from other entities of the operating environment 100 via the network 105. The quantified home 103 may be communicatively coupled to the network 105 via a signal line 120.

The quantified home 103 may include one or more areas. The one or more areas may include rooms in the residence or portions of the residence that serve one or more purposes. For example, the quantified home 103 may include one or more of the following areas: a garbage area 183; a vehicle area 185; and a home area 181. The garbage area 185 may include portion of the quantified home 103 where garbage is aggregated for disposal, recycling or composting. The vehicle area 185 may include portion of the quantified home 103 where the user stores their vehicle. For example, the vehicle area 185 may include a garage, drive way, parking strip or other parking area for a vehicle. The home area 181 may include any portion of the quantified home 103 that is not the garbage area 183 or the vehicle area 185. The quantified home 103 may include one or more different home areas 181. For example, the quantified home 103 may include a bedroom, a bathroom, a television room and any other area of a home that is not the garbage areas 183 or the vehicle areas 185. The bedroom may include one home area 181, the bathroom may include a different home area 181 and the television room may include yet another home area 181. Accordingly, the quantified home 103 may include two or more home areas 181.

The quantified home 103 may include one or more of the following elements: an item set 199; a tag set 123; a reader device 125; a sensor set 121; a hub device 187; and a storage 127. The item set 199 may include one or more items. The tag set 123 may include one or more tags. The one or more items may include any tangible object associated with the quantified home 103 which is affixed with a tag from the tag set 123 and registered with the personal inventory management system. For example, the user may manually affix or couple a tag from the tag set 123 to an item from the item set 199. Optionally, the item may be manufactured with the tag already present in the item. The tag may include an RFID tag or an NFC tag. For the purpose of clarity, both the RFID tag and the NFC tag will be referred to herein as “a tag” or “the tag.” One or more items from the item set 199 may include a bar code or a QR code. The reader device 125 may include a hardware device having a camera and software for detecting and reading tags, bar codes and QR codes. The item set 199, tag set 123 and reader device 125 will be described in more detail below with reference to methods 300, 400 and 500 of FIGS. 3, 4 and 5.

The sensor set 121 may include one or more sensors. The home area 181, garbage area 183 and vehicle area 185 may include their own sensor set 121. Individual areas of the quantified home 103 may include different sensor sets 121, and the individual sensor sets 121 may include different sensors than other sensor sets 121 included in the quantified home 103.

The one or more sensors included in the sensor set 121 may include devices configured to determine one or more physical attributes of the area where they are located. For example, an area may include a sensor to measure the temperature, humidity or any other physical attribute of the area where the sensor is located. The one or more sensors may also include a motion detector sensor or some other sensor configured to detect and track motion in the area where the sensor is located.

The sensor set 121 may include hardware and software to wirelessly communicate with the mobile client device 188. For example, the sensor set 121 may include a wireless antenna for wirelessly transmitting data to the mobile client device 188 via the network 105. The sensor set 121 may wireless transmit sensor data to the mobile client device 188. The sensor data may include data describing the one or more physical attributes of the area where the sensor set 121 is located. The sensor data is described in more detail below with reference to element 291 of FIG. 2.

The hub device 187 may be an optional feature of the quantified home 103. The hub device 186 may include a router or some other device configured to enable the mobile client device 188 or the inventory analytics server 109 to communicate with the elements of the quantified home 103. In one embodiment, the hub device 187 may receive data from one or more elements of the quantified home 103 and transmit the data to the mobile client device 188 or the inventory analytics server 109. The hub device 187 may communicate with the mobile client device 188 or the inventory analytics server 109 via a wired or wireless communicative coupling. For example, signal line 108 may include a hardwired communicative coupling between the quantified home 103 and the mobile client device 188 and signal line 120 may include a wireless communicative coupling between the quantified home 103 and the network 105.

In one embodiment, the sensor set 121 and the one or more reader devices 125 transmit their data to the inventory analytics server 109 and not the mobile client device 188. For example, the hub device 187 may aggregate this data and transmit the data to the inventory analytics server 109 via the network 105. Optionally, the sensor set 121 and the one or more reader devices 125 may transmit this data to the inventory analytics server 109 via the network 105 without use of the hub device 187.

The storage 127 may include a non-transitory storage medium that stores data for providing the functionality described herein. The storage 141 may include a DRAM device, a SRAM device, flash memory, or some other memory devices. In one embodiment, the storage 141 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The social network server 101 may include a hardware server that includes a processor, a memory, and network communication capabilities. The social network server 101 sends and receives data to and from other entities of the operating environment 100 via the network 105. The social network server 101 may be communicatively coupled to the network 105 via a signal line 104.

The social network server 101 may include a social network application 111. The social network application 111 may include code and routines configured to provide a social network service. The social network service may include a social network. A social network may include a type of social structure where the users may be connected by a common feature. The common feature may include relationships/connections, e.g., friendship, family, work, an interest, geographic neighborhood, etc. The common features may be provided by one or more social networking systems including explicitly defined relationships and relationships implied by social connections with other online users, where the relationships form a social graph. In some examples, the social graph may reflect a mapping of these users and how they may be related.

The social network server 101 and the social network application 111 may be representative of one social network, and there may be multiple social networks coupled to the network 105, respectively having their own servers, applications, and social graphs. For example, a first social network may be more directed to business networking, a second may be more directed to or centered on academics, a third may be more directed to local business, a fourth may be directed to dating, and others may be of general interest or a specific focus.

The coupon server 140 may include a hardware server that includes a processor, a memory, and network communication capabilities. The coupon server 140 may send and receive data to and from other entities of the operating environment 100 via the network 105. The coupon server 140 may be communicatively coupled to the network 105 via a signal line 117.

In one embodiment, the coupon server 140 may provide one or more coupons to the user. The coupons may include electronic coupons or tangible coupons. The coupons may be personalized for the user based on an analysis of the items registered with the personal inventory management system. For example, an analysis of the items registered with the personal inventory management system may indicate that the user needs to purchase a particular item. The coupon server 140 may provide the inventory analytics server 109 with an electronic coupon for the item that the user needs to purchase. The inventory analytics server 109 may provide the electronic coupon to the user via the mobile application 190. A tangible coupon and an electronic coupon may be referred to herein collectively or individually as “a coupon” or “the coupon.”

In one embodiment, the inventory analytics server 109 may provide the electronic coupon to the user via e-mail, text message or any other form of communication. In one embodiment, the coupon server 140 may cause a tangible coupon to be mailed to the shipping address associated with the quantified home 103.

In one embodiment, the coupon server 140 may include functionality to provide the user of the mobile client device 188 with a targeted advertisement. For example, the coupon manager engine 161 may provide data to the coupon server 140 describing one or more products that the user may be want to purchase. The coupon server 140 may provide a targeted advertisement to the mobile client device 188. For example, the coupon server 140 may cause the browser 137 to display an advertisement for the mobile client device 188 to display a targeted advertisement for the one or more products indicated by the coupon manager engine 161. The targeted advertisement may include a coupon for purchasing the product. The coupon manager engine 161 may identify the one or more products based on the items included in the item set 199 or the user's historical use of items included in the item set 199. In one embodiment, the targeted advertisement may also be provided to the user via e-mail, text message, a phone call, or any other form of communication.

The inventory analytics server 109 may include a hardware server that includes a processor, a memory, and network communication capabilities. The inventory analytics server 109 may send and receive data to and from other entities of the operating environment 100 via the network 105. The inventory analytics server 109 may be communicatively coupled to the network 105 via the signal line 105.

The inventory analytics server 109 may include one or more of the following elements: a recommendation engine 151; a search engine 153; a social engine 155; an item status manager engine 157; a location manager engine 159; a coupon manager engine 161; and a data repository 163.

The data repository 163 may include a non-transitory storage medium that stores data for providing the functionality described herein for the elements of the inventory analytics server 109. For example, the data repository 163 may store inventory data, history data and sensor data for the one or more items included in the item set 199. The inventory data, sensor data and history data are described in more detail below with reference to elements 285, 289 and 291 of FIG. 2, respectively.

The data repository 163 may also store social network data received from the social network application 111. The data repository 163 may also store graphical data used to generate one or more GUIs.

The data repository 163 may include a DRAM device, a SRAM device, flash memory, or some other memory devices. In one embodiment, the data repository 163 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The recommendation engine 151 may include code and routines configured to provide a recommendation service. For example, the recommendation engine 151 may determine one or more recommendations for the user. The recommendation engine 151 may provide the user with the one or more recommendations via the mobile client device 188.

The recommendation engine 151 may determine the one or more recommendations for the user based on an analysis of the item set 199, the user's historical use of the items included in the item set 199 or some other relevant factor. For example, the recommendation engine 151 may determine that the user may be able to save money by purchasing a product that is equivalent to one of the items included in the item set 199. The product may be a generic product that is equivalent to one of the items included in the item set 199. The product may be a competing product that would be cheaper because of the available of an electronic coupon or some other factor. In another example, the recommendation engine 151 may identify and recommend a product that has less environmental impact versus one of the items included in the item set 199.

In one embodiment, the user may request information about the existence of products that may be cheaper or have less environmental impact using a GUI of the mobile application 190 and the recommendation engine 151 may identify these products and provide information describing these products to the user.

In one embodiment, the recommendation engine 151 may determine that the user is running low on inventory for a particular item and the recommendation engine 151 may provide the mobile client device 188 with a recommendation that the user purchase a replacement for the item. The recommendation engine 151 may analyze the user's historical use of the item to determine that the user is running low on inventory for the item. The user may also provide the recommendation engine 151 with input via the mobile application 190 or the browser 137 to indicate a threshold for when the user is running low on inventory for a particular item. The recommendation engine 151 may analyze the inventory for an item. For example, the recommendation engine 151 may analyze the inventory for an item when the item enters the garbage area 183 or the vehicle area 185 to determine whether the threshold for the item has been met. In this way, the recommendation engine 151 may ensure that the user maintains adequate inventory of items in the quantified home 103.

In one embodiment, the user may have configured the recommendation engine 151 to include payment information, shipping information and authorization to automatically purchase an item from an online store in the event that inventory is running low. For example, the recommendation engine 151 may determine that the user is running low on inventory for an item and then take steps to purchase a sufficient number of items from an online store to ensure that the user maintains adequate inventory of this item in the quantified home 103.

In one embodiment, the mobile application 190 may include functionality to enable the user to identify products that should generally be present in the quantified home 103. For example, the user may provide an input to indicate which items should generally be present in the quantified home 103. The user may provide an input to indicate that toothpaste should be present in the quantified home 103. The recommendation engine 151 may notify the user if the item is no longer present in the quantified home 103, has expired or will expire in the future. Optionally, the recommendation engine 151 may take steps to proactively purchase the item from an online store. The expiration management functionality of the inventory analytics server 109 is described in more detail below with reference to the item status manager engine 157.

In one embodiment, the recommendation engine 151 may analyze sensor data to identify if an item has been exposed to physical attributes that affect the item. The recommendation engine 151 may take steps to notify the user about the status of the item. The recommendation engine 151 may also take steps to update the expiration date for the item to an earlier date based on the exposure to the physical attributes. The recommendation engine 151 may also work with the coupon manager engine 161 to identify and provide a coupon to the user to replace the item. This functionality will be described in more detail below.

In one embodiment, the recommendation engine 151 may identify if an item is leaving an area of the quantified home where it is supposed to be constrained and notify the user about the status of the item (or notify a security system included in the quantified home about a possible burglary). For example, if the item is jewelry and it leaves the area of the quantified home 103 where it is supposed to be constrained, then the recommendation engine 151 may take steps to notify the user, the security system or the local police.

In one embodiment, the recommendation engine 151 may identify if an item is entering an area of the quantified home 103 where it is not supposed to be located and then take steps to notify the user about the status of the item. For example, if the item is a gun that enters a child's bedroom, then the recommendation engine 151 may take steps to notify the user about the status of the item.

In one embodiment, the recommendation engine 151 may identify one or more coupons for the user. The coupon may be a coupon for a brick and mortar store or an online store. The coupon may be an electronic coupon that may be electronically communicated to the mobile client device 188 or a tangible coupon that is mailed to the mailing address of the quantified home 103 (or some other mailing address associated with the user). The recommendation engine 151 may identify the coupon responsive to determining that the user is running low on inventory for a particular item or that an item has expired or will expire in the future. The coupon may be for a cheaper price on a product that matches the particular item that is included in the inventory of the user or an equivalent item. The recommendation engine 151 may monitor the rate at which the user uses different products and provide the coupons to the user in advance of the user running low on inventory.

In one embodiment, the coupons may be selected based in part on item-to-item collaborative filtering techniques. In one embodiment, the coupons may be communicated to the user so that the user is likely to leave the quantified home 103 during periods of high electricity prices or energy shortages. The coupon service functionality of the inventory analytics server 109 is described in more detail below with reference to the coupon manager engine 161.

The search engine 153 may include code and routines configured to provide a search engine service. For example, the search engine 153 may enable the user of the mobile client device 188 to search for information included in the personal inventory management system (e.g., data stored in one or more of the data repository 163, the storage 127 or the storage 141) or determined based on an analysis of data stored in the personal inventory management system. Assume, for example, that the user of the mobile client device 188 wants to locate an item in the quantified home 103. The mobile application 190 may include a GUI including functionality configured to enable the user to provide a search query to the mobile application 190. The search query may include one or more keywords configured to return a search result that specifies the location of the item (e.g., the search query may include “where is the item?” or some similar or equivalent query). The mobile application may receive the search query and transmit the search query to the network 105. The network 105 may transmit the search query to the inventory analytics server 109. The search engine 153 may query the data repository to identify history data that describes the location of the item in the quantified home 103. The search engine 153 may cause the mobile application 190 to display a search result to the user that describes the location of the item in the quantified home 103.

Other search queries are possible. For example, the user may provide a search query configured to provide one or more of the following search results: whether an item is still available in the quantified home 103; the areas in the home which a particular item has visited; the temperatures or other physical attributes which an item has been exposed to; potential alternative products that may be cheaper or greener; and the last person who likely interacted with an item (e.g., one of the sensors of the sensor set 121 is a video camera and the mobile application mobile application 190 or the inventory analytics server 109 may include image recognition technology configured to identity a user that interacted with the item). The preceding list is provided by way of example and not intended to be limiting.

The social engine 155 may include code and routines configured to provide the social network features to the personal inventory management system. The social engine 155 may enable the user to connect or integrate one or more social networks services provided by the social network application 111 with the functionality provided by the personal inventory management system. For example, the user of the mobile client device 188 may access the mobile application 190 and provide inputs authorizing the social network application 111 to share social graph data with the inventory analytics server 109 or the mobile client device 188. The social engine 155 may include one or more application programming interfaces to enable the inventory analytics server 109 or the mobile client device 188 to exchange data and information with the social network application 111.

In one embodiment, one or more of the mobile application 190, the social engine 155 and the recommendation engine 151 may cooperate and communicate with one another to provide to provide social network functionality to the user. For example, one or more users of the personal inventory management system may live within a predefine area of one another (e.g., five miles or any other range). The one or more users may be connected with one another via the social network service provided by the social network application 111. The one or more users may modify the privacy settings of the personal inventory management system so that other users may view the items in their respective quantified homes 103. The one or more users may use this functionality to borrow items from one another or sell items to one another. For example, the mobile application 190 may display a GUI displaying items that are available for borrowing or purchasing and the user may select an item and take steps within the mobile application 190 to borrow or purchase the selected item. The social engine 155 may include code and routines configured to retrieve any data from the social network application 111 that is used to enable the mobile application 190 to generate the GUI and facilitate the user borrowing or purchasing the selected item. In one embodiment, the recommendation engine 151 may include code and routines configured to filter items presented for borrowing or purchasing so that only users who may be interested in an item receive the offer to borrow or purchase the item. The interest level of the user may be based the recommendation engine 151 analyzing the user's preferences and what items the user already owns. In this way, one or more of the mobile application 190, the social engine 155 and the recommendation engine 151 may cooperate and communicate with one another to provide social network functionality to the user.

In one embodiment, users may also advertise their availability to assist other users via the social network functionality. For example, a user may advertise that they are available to assist other users in moving furniture. Users may contact one another via a GUI of the mobile application 190 so that they may borrow items, sell items or provide services to one another. Borrowing items or providing services as described above may be fee based or provided free of charge.

In one embodiment, a user of the mobile client device 188 may use the mobile application 190 to transmit send a request for an item which they need to borrow. For example, the user may desire to borrow a cart instead of buying one. The mobile application 190 may include code and routines configured to route the request a neighbor who has the item in question. The user and the neighbor may be connected to one another via the social network service provided by the social network application 111. The user may be referred to as a requestor since they are requesting an item from the neighbor. The neighbor may respond to the requestor. The neighbor may indicate that the requestor can borrow the item. In one embodiment, the identity of the neighbor is not revealed to the requestor unless they agree to allow the requestor to borrow the item. If the neighbor provides an input indicating that they decline to allow the requestor to borrow the item, the mobile application 190 may identify another social network connection that also has the item which is being requested in their personal inventory. If the mobile application 190 cannot identify a social connection that is willing to let the requestor borrow the item, then the coupon manager engine 161 may identify a coupon for purchasing the item (or a similar product) from a vendor. The coupon manager engine 161 may take steps to cause the coupon to be transmitted to the mobile client device 188 or the quantified home 103.

In one embodiment, the administrator of the inventory analytics server 109 may receive a percentage of the sell price for an item or service that is sold, borrowed or provided.

The item status manager engine 157 may include code and routines configured to provide an expiration date management service. For example, the item status manager engine 157 may aggregate one or more expiration dates for items included in the item set 199 and provide notifications to the user of the mobile client device 188 so that they are aware of product expirations in advance of their respective expiration date may take actions to replace items that will have expired or may expire in the future. For example, the product registration process may include one or more of the following: the user inputting the product expiration date for each registered item; the user taking a picture of the item using the mobile client device 188 so that the picture includes text describing the product expiration date and the item status manager engine 157 analyzing the picture to identify and record the product expiration date; the user scanning a bar code or QR code of the item and the item status manager engine 157 determining the product expiration date based on information included in the bar code or QR code; and the expiration manger inferring the expiration date based on other data.

The item status manager engine 157 may store the expiration dates for the items included in the item set 199 in the data repository 163. The item status manager engine 157 may track the expiration dates and check them against a current date. The item status manager engine 157 may identify an item from the item set 199 that may expire in the future or has presently expired. The item status manager engine 157 may check the data repository 163 for data to ensure that the item is still present in the quantified home 103. The item status manager engine 157 may notify the user of the mobile client device 188 that the item has expired or will expire in the future.

In one embodiment, the item status manager engine 157 initiate an search to identify a store that sells a product that is the same or similar to the item which is expired (or will expire in the future) and provides a notification to the user that provides the user with information that may be used to purchase the identified product.

In one embodiment, the item status manager engine 157 may update the expiration date for an item responsive to the recommendation engine 151 determining that the item was exposed to physical attributes that affect the quality of the item.

In one embodiment, the item status manager engine 157 may also take steps to automatically purchase a replacement for the item, retrieve a coupon for replacing the item, or notify the user about the need to purchase the replacement or coupons for replacing the item. In this way, the item status manager engine 157 may ensure that items are replaced or replenished in a timely fashion before they expire or when they expire.

The location manager engine 159 may include code and routines configured to provide an item location management service. For example, the location manager engine 159 may keep track of the location of one or more items included in the item set 199. The location manager engine 159 may detect when an item moves to the garbage area 183, to the vehicle area 185 or outside the quantified home 103. The location manager engine 159 may communicate with the search engine 153 and use the item data 281 for the item to initiate a search for a product that matches the item data 281 or a product that is equivalent to the item data 281. The location manager engine 159 may also take steps to automatically purchase the identified product, retrieve a coupon for the identified product, or notify the user about the identified product or coupons for the identified product. In this way, the location manager engine 159 may ensure that items are replaced or replenished in a timely fashion.

The coupon manager engine 161 may include code and routines configured to provide a coupon service. For example, the coupon manager engine 161 may interact with the coupon server 140 to identify and acquire coupons for products that the user may want to purchase. The coupon manger engine 161 may interact with one or more of the other elements of the operating environment 100 to provide the coupon service. In one embodiment, the coupon manager engine 161 may interact with one or more elements of the operating environment to provide the user with one or more targeted advertisements based on the items included in the item set 199 or the user's historical use of items included in the item set 199.

Referring now to FIG. 2, a block diagram of an example of the mobile client device 188 is described. The mobile client device 188 may include one or more of the following elements: the mobile application 190; a camera 221; a processor 225; a communication unit 245; the browser 137; the reader module 139; and a memory 227. The components of the mobile client device 188 may be communicatively coupled by a bus 220.

The browser 137 and the reader module 139 were described above with reference to FIG. 1, and so, these descriptions will not be repeated here. The browser 137 may be communicatively coupled to the bus 220 via a signal line 242. The reader module 139 may be communicatively coupled to the bus 220 via a signal line 240.

The camera 221 includes a hardware camera device configured to capture images. For example, the camera 221 may capture an image of a QR code for an item. The reader module 139 may then analyze the image to detect and read the QR code as described above.

The processor 225 may include an arithmetic logic unit, a microprocessor, a general-purpose controller, or some other processor array to perform computations and provide electronic display signals to a display device. The processor 225 may be communicatively coupled to the bus 220 for communication with the other components via a signal line 248. The processor 225 may process data signals and may include various computing architectures including a complex instruction set computer (CISC) architecture, a reduced instruction set computer (RISC) architecture, or an architecture implementing a combination of instruction sets. Although FIG. 2 includes a single processor 225, multiple processors 225 may be included. Other processors, operating systems, sensors, displays, and physical configurations may be possible.

The communication unit 245 transmits and receives data to and from at least one of the elements of the operating environment 100 described above with reference to FIG. 1. The communication unit 245 may be communicatively coupled to the bus 220 via a signal line 246. In one embodiment, the communication unit 245 includes a port for direct physical connection to the network 105 or to another communication channel. For example, the communication unit 245 includes a USB, SD, CAT-5, or similar port for wired communication with other entities in the operating environment 100. In one embodiment, the communication unit 245 includes a wireless transceiver for exchanging data with other entities in the operating environment 100 or other communication channels using one or more wireless communication methods, including IEEE 802.11, IEEE 802.16, Bluetooth®, or another suitable wireless communication method.

In one embodiment, the communication unit 245 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In one embodiment, the communication unit 245 includes a wired port and a wireless transceiver. The communication unit 245 may also provide other conventional connections to the network 105 for distribution of files or media objects using standard network protocols including TCP/IP, HTTP, HTTPS, and SMTP, etc.

The memory 227 may include a tangible computer-readable storage medium. The memory 227 may store instructions or data that may be executed by the processor 225. The memory 227 may be communicatively coupled to the bus 220 for communication with the other components via a signal line 244. The instructions or data may include code for performing the techniques described herein. The memory 227 may include a DRAM device, a SRAM device, flash memory, or some other memory device. In one embodiment, the memory 227 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The memory 227 may store code and routines that may include executed by the processor 225. For example, the memory 227 may store one or more modules 202, 129, 131, 139 or the browser 137 which may be executed by the processor 225.

The memory 227 may store one or more of the following elements: image data 279; item data 281; reader data 283; inventory data 285; description data 287; history data 289; and sensor data 291. The memory 227 may also store other data for providing the functionality described herein.

The image data 279 may include data describing one or more images captured by the camera 221. For example, the image data 279 may include images of one or more items. The images may include data associated with the item. For example, the one or more images may include one or more of the following: a QR code; a bar code; and an expiration date.

The item data 281 may include data identifying the one or more items. The item data 281 may include a data structure such as a table or a database. The data structure may include data for identifying items based off a QR code or a bar code. The reader data 283 may include identifying information associated with the item. The combination of the item data 281 and the reader data 281 for an item may be used to determine the identity of the item. For example, the camera 221 may capture image data 279. The image data 279 may describe an image including a QR code or a bar code. The reader module 139 may analyze the image data to determine the reader data 283 included in the QR code or the bar code. The reader module 139 may determine the reader data 283 from the QR code or the bar code. The reader module 139 may cross reference the reader data 283 against the data structure described by the item data 281 to determine the identity of the item based off the reader data 283 included in the QR code or bar code. Optionally, the reader module 139 may use the reader data 283 to query the data structure described by the item data 281 to determine the identity of the item.

In one embodiment, the item data 281 is stored on a server such as the inventory analytics server 109 and the reader module 139 interacts with the server to determine the identity of the item based on one or more of the image data 279, the reader data 283 and the item data 281.

The inventory data 285 may include data describing the identity of one or more items. For example, the inventory data 285 may include data describing the identity of one or more items included in the item set 199 described above with reference to FIG. 1. The inventory data 285 may be determined based on item data 281. The inventory data 285 may include data identifying the items included in the item set 199.

The description data 287 may include data describing the items identified by the inventory data 285. For example, for a given item the description data 287 may describe the expiration date for the item, whether the item should generally be present in the quantified home 103, any limitations on the physical attributes which the item should exposed to when present in the quantified home 103, and any limitations on where the item should be located within the quantified home 103 (e.g., the item should be constrained to one or more areas or the item should not be present in a particular area). The description data 287 may also describe what actions should be taken if an item leaves an area where it is constrained or enters an area where it should not be present.

In one embodiment, the description data 287 may be included in the inventory data 285. In one embodiment, the inventory data 285 and the description data 287 may be stored as separate but associated columns in a table or data set. For example, the inventory data 285 may identify one or more items and the description data 287 may describe these items.

The history data 289 may describe the history of one or more of the items included in the item set 199. For example, the history data 289 may describe the areas of the home where the item has been present and the day and times when the item was present in those locations. The history data 289 may describe the history of one or more of the items identified by the inventory data 285 and described by the description data 287.

The sensor data 291 may describe one or more physical attributes associated with an item. For example, the sensor data 291 may describe one or more physical attributes detected by the one or more sensors included in the sensor set 121 described above with reference to FIG. 1. The sensor data 291 may describe the physical attributes that one or more items were exposed to when present in the quantified home 103. The one or more items may be the items identified by the inventory data 285 and described by the description data 287.

The mobile application 190 may include one or more of the following elements: a communication module 202; the interface module 129; and the registration engine 131. The interface module 129 and the registration engine 131 were described above with reference to FIG. 1, and so, these descriptions will not be repeated here.

The communication module 202 may include code and routines configured to handle communications between the mobile application 190 and other components of the mobile client device 188. The communication module 202 may send and receive data, via the communication unit 245, to and from one or more of the operating environment 100 described above with reference to FIG. 1. For example, the communication module 202 transmits, via the communication unit 245, some or all of the data 279, 281, 283, 285, 287, 289, 291 stored on the memory 227 to the inventory analytics server 109 so that the data 279, 281, 283, 285, 287, 289, 291 may be stored in the data repository 163. The user may choose data to be uploaded based on the privacy preference.

In one embodiment, one or more modules of the mobile application 190 may be stored in a single server or device. In some other embodiments, one or more modules of the mobile application 190 may be distributed and stored across multiple servers or devices. Furthermore, the separation of various components, modules, and servers in the embodiments described herein should not be understood as requiring such separation in all embodiments. In one embodiment, the described components, modules, devices, or servers may generally be integrated together in a single component, module, device, or server.

In one embodiment, the modules 202, 129, 131, 139 and the browser 137 may include a set of instructions executable by the processor 225 to provide the functionality described herein. In some other implementations, the modules 202, 129, 131, 139 and the browser 137 may be stored in the memory 227 and may be accessible and executable by the processor 225 of the mobile client device 188. The modules 202, 129, 131, 139 and the browser 137 may be adapted for cooperation and communication with the processor 225 and other components of the mobile client device 188. In one embodiment, the modules 202, 129, 131, 139 and the browser 137 may be adapted to function as one or more thin clients that are stored and executed by a processor 225.

Referring now to FIG. 3, an example of a method 300 to register an item with the personal inventory management system is described. The blocks of the method 300 may be performed in any order. Although illustrated as discrete blocks, various blocks may be divided into additional blocks, combined into fewer blocks, or eliminated, depending on the desired implementation. The method 300 will be described below with reference to FIGS. 1 and 2.

At block 301, the user may couple a tag to an item. For example, the user may affix the tag to the item. In one embodiment, the item may be manufactured to include the tag and block 301 may be skipped. At block 302, the presence of the tag may be detected. For example, the tag may be detected by the reader module 139 of the mobile client device 188. At block 304, image data 279 may be received. For example, the camera 221 may capture an image of an item to be registered. The image may include a visual depiction of a bar code or QR code which is included on the item. At block 306, reader data 287 may be determined based on a bar code or QR code included in the image data 279 which describes the image. At block 308, the identity of the item may be determined based on the reader data 287. At block 310, the tag may be associated with the item. For example, inventory data 285 may be generated that includes an indication of the item and the tag associated with the item. At block 312, the description data 287 for the item may be received. The user may provide some or all of the description data 287 via one or more inputs to the mobile application 190 of the mobile client device 188. In some embodiments, some or all of the description data 287 may be received based on the identity of the item being determined from the reader data 283. At block 314, data associated with the item may be transmitted to the network 105. The data may include one or more of the following: the image data 279; the item data 281; the reader data 283; the inventory data 285; and the description data 287.

In one embodiment, the personal inventory for the user may be updated to indicate that the item is present in the qualified home 103. When the status of an item included in the inventory is updated (e.g., the item is consumed, moved, or discarded), the inventory data 285 may be changed (e.g. the item is consumed or discarded) or the history data 289 may be changed (e.g., the item is moved to a different area) to reflect the updated status of the item.

The data stored by the mobile client device 188 may be shared with the inventory analytics server 109 so that the inventory analytics server 109 may provide one or more services to the user. For example, the inventory analytics server 109 may provide one or more of the following services to the user based in part on the data shared with the inventory analytics server 109: a recommendation service, search engine service, expiration date management service, a location management service, and a coupon service.

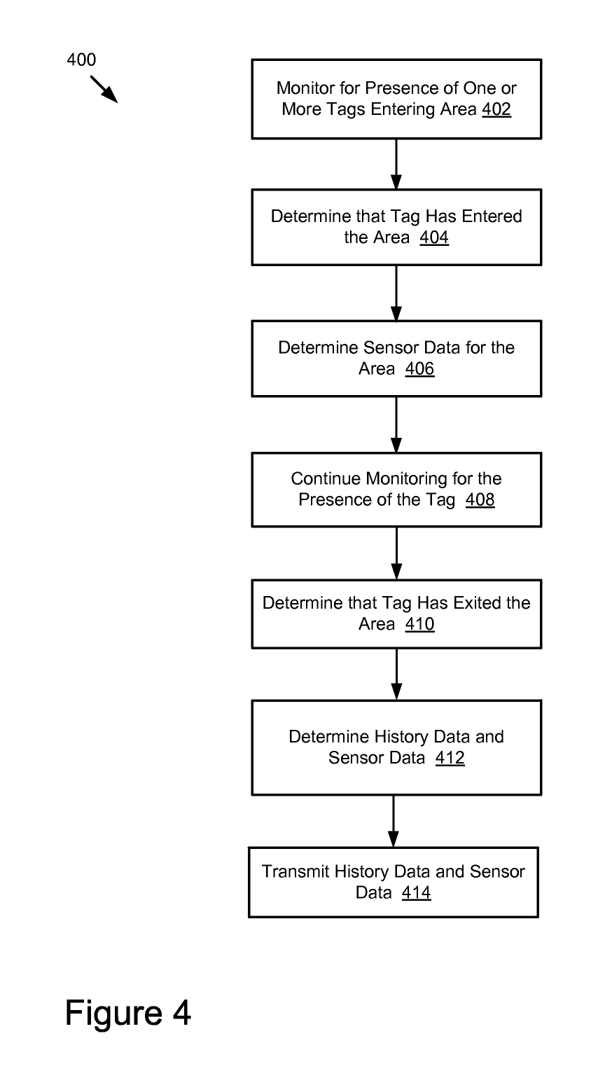

Referring now to FIG. 4, an example of a method 400 to track an item in the quantified home 103 is described. The blocks of the method 400 may be performed in any order. Although illustrated as discrete blocks, various blocks may be divided into additional blocks, combined into fewer blocks, or eliminated, depending on the desired implementation. The method 400 will be described below with reference to FIGS. 1 and 2.

Block 402 may include monitoring for the presence of one or more tags entering an area. For example, the reader device 125 may monitor for the presence of the tag in the home area 181. At block 404, a determination may be made regarding whether the tag has entered the area. For example, the reader device 125 may detect the presence of the tag in the home area 181. At block 406, sensor data 291 for the area may be determined. For example, the sensor set 121 for the home area 181 may determine one or more physical attributes of the home area 181 after the tagged item enters the home area 181. At block 408, monitoring for the presence of the tag may continue. For example, the reader device 125 may monitor the presence of the tag to determine when or if it exits the home area 181. At block 410, it may be determined that the tag has exited the area. For example, the reader device 125 may determine that the tag has exited the home area 181. At block 412, history data 289 and sensor data 291 may be determined. The history data 289 may describe the time when the tagged item entered the home area 181 and the time when the item left the home area 181. The sensor data 291 may describe the physical attributes present in the home area 181 while the tagged item was present in the home area 181. At block 414, the history data 289 and the sensor data 281 may be transmitted. For example, the history data 289 and the sensor data 281 may be transmitted to the network 105 or the mobile client device 188.

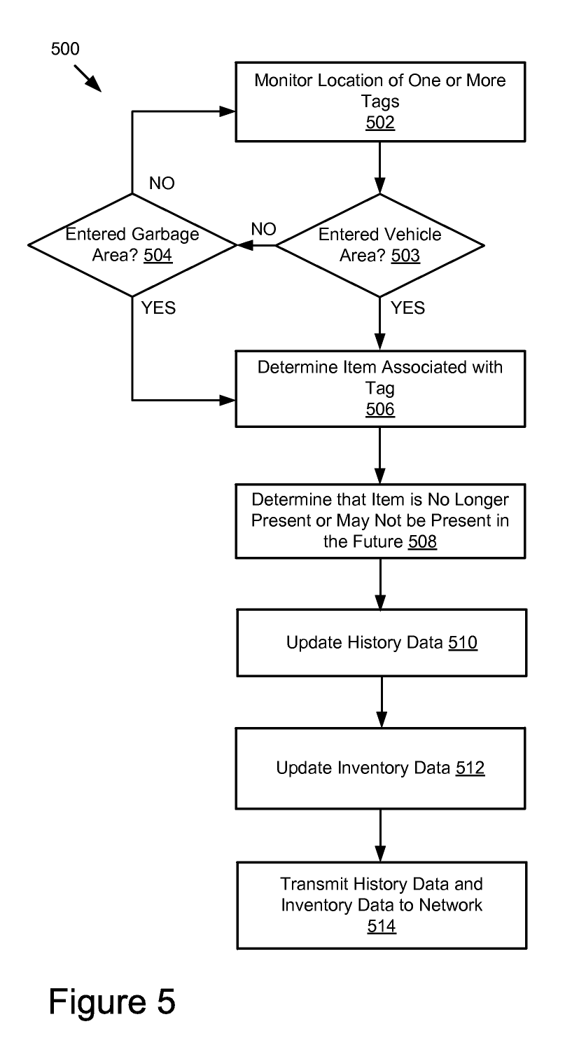

Referring now to FIG. 5, an example of a method 500 to update the status of an item with the personal inventory management system is described. The blocks of the method 500 may be performed in any order. Although illustrated as discrete blocks, various blocks may be divided into additional blocks, combined into fewer blocks, or eliminated, depending on the desired implementation. The method 500 will be described below with reference to FIGS. 1 and 2.

Block 502 may include monitoring the location of one or more tags. For example, the mobile application 190 may monitor for history data 289 indicating the presence of the tag within the quantified home 103. At block 503, a determination may be made regarding whether a tag has entered the vehicle area 185. If the tag has not entered the vehicle area 185, the method 500 may proceed to block 504. If the tag has entered the vehicle area 185, then the method 500 may proceed to block 506. Block 506 will be described in the subsequent paragraph. At block 504, a determination may be made regarding whether the tag has entered the garbage area 183. If the tag has not entered the garbage area 183, then the method 500 may proceed to block 502. If the tag has entered the garbage area 183, then the method 500 may proceed to block 506.

At block 506, the item associated with the tag may be determined. A block 508, a determination may be made that the tag is no longer present in the quantified home 103 or will not be present in the quantified home 103 in the future. At block 510, the history data 289 for the item may be updated. At block 512, the inventory data may 285 for the item be updated. At block 514, the history data 289 and the inventory data 285 may be transmitted to the network 105.

The embodiments described herein may include the use of a special-purpose or general-purpose computer including various computer hardware or software modules, as discussed in greater detail below. For example, one or more elements of the operating environment 100 may include or be combined to form a special-purpose computer programmed to executed one or more blocks of the methods 300, 400, 500 described above with reference to FIGS. 3, 4 and 5.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions comprise, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general-purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general-purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that various changes, substitutions, and alterations could be made hereto without departing from the spirit and scope of the invention.

What is claimed is:

1. A system comprising:
a quantified home including an item set and one or more reader devices, the item set includes an item and a tag that is affixed to the item and configured to be monitored by the one or more reader devices;
a mobile client device communicatively coupled to the one or more reader devices via a wireless network and configured to register the item included in the item set with a personal inventory of the quantified home and receive description data describing a set of conditions associated with the item; and
an inventory analytics server communicatively coupled to the mobile client device via the wireless network and configured to receive the description data and history data describing movement of the item within the quantified home;
the one or more reader devices configured to monitor one or more areas of the quantified home and movement of the tag within the quantified home to generate the history data, the movement of the tag indicates movement of the item; and
the inventory analytics server configured to analyze the description data and the history data to determine that a condition included in the set of conditions has been met and initiate an action specified by a user of the personal inventory responsive to the condition being met.

2. The system of claim 1, wherein the quantified home is a personal residence of a user.

3. The system of claim 1, wherein the description data is provided via user input to the mobile client device and the one or more conditions and the action are defined by the description data.

4. The system of claim 1, wherein the tag is a radio-frequency identification tag and the one or more reader devices wirelessly detect movement of the tag to determine movement of the tag to indicate that the item has entered an area of the quantified home.

5. The system of claim 1, wherein the one or more conditions include an analysis indicating that the item is not available or will not be available in the future.

6. The system of claim 5, wherein the action includes updating the personal inventory to indicate that the item is not available and notifying a user of the mobile client device and the quantified home about the status of the item.

7. The system of claim 5, wherein the action includes:
identifying a replacement for the item, wherein the replacement is a product that is identical to the item or substantially similar to the item;
identifying a store for purchasing the replacement; and
notifying a user of the personal inventory about the status of the item and the store for purchasing the replacement.

8. The system of claim 5, wherein the action includes:
identifying a replacement for the item, wherein the replacement is a product that is identical to the item or substantially similar to the item;
identifying a coupon associated with purchasing the replacement; and
notifying a user of the personal inventory about the status of the item and the coupon associated with purchasing the replacement.

9. The system of claim 5, wherein the action includes:
identifying a replacement for the item, wherein the replacement is a product that is identical to the item or substantially similar to the item; and
causing a user of the personal inventory to be presented with a targeted advertisement associated with purchasing the replacement.

10. The system of claim 1, wherein the one or more conditions include the item leaving an area where it is constrained and the action includes triggering a security system associated with the quantified home.

11. A system comprising:
a quantified home including an item set, one or more reader devices and a sensor set, the item set includes an item and a tag that is affixed to the item and configured to be monitored by the one or more reader devices;
a mobile client device communicatively coupled to the one or more reader devices and the sensor set via a wireless network and configured to register the item included in the item set with a personal inventory of the quantified home; and
an inventory analytics server communicatively coupled to the mobile client device via a wireless network and configured to receive description data describing a set of conditions associated with the item, history data describing movement of the item within the quantified home and sensor data describing the one or more physical attributes present in the quantified home and associated with the item;
the one or more reader devices configured to monitor one or more areas of the quantified home and movement of the tag within the quantified home to generate the history data, movement of the tag indicates movement of the item;
the sensor set is configured to measure and record one or more physical attributes present in the one or more areas of the quantified home and associated with the item and movement of the item; and
the inventory analytics server is configured to analyze the history data and the sensor data to determine that a condition included in the set of conditions has been met and initiate an action specified by a user of the personal inventory responsive to the condition being met.

12. The system of claim 11, wherein the description data includes an expiration date associated with the item and a threshold associated with the item, and the sensor data and the history data indicate that the item was stored in an area of the quantified home when a physical attribute for the area exceeded the threshold.

13. The system of claim 12, wherein the action includes modifying the expiration date to be an earlier date.

14. The system of claim 12, wherein the action includes notifying the user of the personal inventory that the threshold was exceeded.

15. The system of claim 12, wherein the action includes causing a replacement for the item to be purchased.

16. The system of claim 12, wherein the threshold is a temperature threshold and the sensor data and the history data indicate that the item was stored in an area of the quantified home when the temperature for the area exceeded the temperature threshold.

17. The system of claim 12, wherein the tag is a near field communication tag and the one or more reader devices determine movement of the tag based on the user touching the tag to the reader device to indicate that the item has entered an area of the quantified home and the sensor set measures and records the one or more physical attributes of the area that the item has entered responsive to the user touching the tag to the reader device.

18. A system comprising:
a processor based computing device communicatively coupled to a wireless network and configured to provide a social network service to one or more users of a personal inventory management system, the one or more users include a requestor and one or more social network connections associated that are associated with the requestor in the social network service; and
one or more quantified homes associated with the one or more users and communicatively coupled to the wireless network, the one or more quantified homes include one or more reader devices and one or more item sets, the one or more item sets include one or more items and one or more tags that are affixed to the one or more items and configured to be detected by the one or more reader devices so that the one or more items may be registered in the personal inventory management system so that the requestor may view the one or more item sets included on the one or more quantified homes associated with the one or more users via a mobile client device communicatively coupled to the wireless network;
the mobile client device is configured to display a graphical user interface configured to receive a request from the requestor and the personal inventory management system is configured to receive the request.

19. The system of claim 18, wherein one of the items included in the one or more item sets is available for purchase via an electronic garage sale service provided by the personal inventory management service and the request includes data associated with the item available for purchase.

20. The system of claim 18, wherein the request describes an item that the requestor would like to borrow and the personal inventory management system attempts to identify a user from the one or more users who will let the requestor borrow the item.

21. The system of claim 20, wherein the requestor is unable to borrow the item and the personal inventory management system identifies a coupon associated with purchasing the item from a vendor and causes the coupon to be transmitted to the user.
